(19) United States
(12) Patent Application Publication
(10) Pub. No.: US 2009/0248451 A1
(43) Pub. Date: Oct. 1, 2009

(54) METHOD, SYSTEM AND MEDIA FOR SPECIFIED EXPENSE COVERAGE LIFE INSURANCE POLICIES

(76) Inventor: Solomon Goldfinger, Flushing, NY (US)

Correspondence Address: Ostrow Kaufman & Frankl LLP;Susan Formicola, The Chrysler Building, 405 Lexington Avenue, 62nd Floor, NEW YORK, NY, 10174, US

(21) Appl. No.: 12/054,781

(22) Filed: Mar. 25, 2008

(51) Int. Cl. G06Q 40/00

(52) U.S. Cl. 705/4

(57) ABSTRACT

A method and system provides a life insurance policy for an insured party to a policy owner for the benefit of a beneficiary, where the life insurance policy covers recurring expenses. The method and system includes generating a recurring expense life insurance policy for the policy owner for the benefit of the beneficiary, where the life insurance policy has a defined policy term. The method and system further includes that upon the death of the insured party within the policy term, paying a recurring expense for a benefit period for the beneficiary under the terms of the recurring expense life insurance policy.

### COPYRIGHT NOTICE

A portion of the disclosure of this patent document includes material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

This invention relates to the field of life insurance and more particularly, to methods, systems and computer media for providing life insurance policies and benefits directed to specified expenses for a beneficiary.

### BACKGROUND OF THE INVENTION

Life insurance is a well known and commonly employed technique for providing additional levels of security for individuals and families in the event of death. There are numerous life insurance policies for providing benefits to the insured as well as the beneficiaries.

Life insurance policies are typically within the larger context of financial or family planning activities. Existing life insurance policies offer a death benefit for the defined beneficiary, which is paid out in a single lump sum payment. This death benefit is meant to allow the beneficiary to financially cushion the blow of the insured's death and perhaps financially maintain an existing lifestyle.

Life insurance with a lump sum payment does not direct itself to specific expenses of the insured nor to the time frame(s) in which such expenses may be due. For example, grieving families may have standard recurring expenses that can be immediately due prior to the pay-out of a death benefit. Additionally, the beneficiary may be unfamiliar with the recurring expenses, such as in the case of a widow whose significant other always handled the bills. Specified or recurring expenses may include mortgage or rent payments, tuition, utilities, gas, electric, phone, cable, groceries, etc.

It is also recognized that many people forego purchasing standard life insurance for any number of reasons, including (1) the perceived high cost of insurance coverage, (2) potential difficulty in finding an agent through which to purchase insurance, and (3) difficulty in determining what insurance to purchase, how much coverage is needed and other complexities of the insurance product and underwriting process.

### SUMMARY OF THE INVENTION

In some embodiments, the present invention overcomes the above-noted and other shortcomings of the prior art. In some embodiments a method of providing life insurance for an insured is provided which includes providing a plurality of options where each option corresponds to any recurring expense of the insured and life insurance for the existing or potential recurring expense, receiving a selection of one or more options of the plurality of options, receiving information relating to the amount of the expense associated with each of the one or more selected options, computing a premium for providing the life insurance policy based at least in part on the one or more selected options and the amount of each associated expense, generating a life insurance policy for the insured based at least in part on the selection, and receiving one or more premium payments for the life insurance policy.

In some embodiments, the recurring expense is an existing expense, in others a future expense, and in still others, a potential expense. The recurring expense may be of any variety or type, including without limitation mortgage expenses, rental expenses, lease expenses, utility expenses, transportation expenses, food expenses, education expenses. In some embodiments, the amount of the expense is variable and in others it is fixed. In some embodiments, an entity other than the issuer of the life insurance provides the plurality of options and may also receive the premium payments. In some instances, the generated life insurance policy provides for benefits to be paid directly to a provider of a product or service for which a recurring expense is incurred, and in some cases, the option for the insurance policy may be provided at the time of obtaining the product or service.

In some embodiments, the present invention provides a life insurance policy for the benefit of a beneficiary through a more direct, simplified acquisition process, where the life insurance policy covers specified or recurring expenses, at a lower cost than traditional insurance products.

In one embodiment, the method and system includes generating a recurring expense life insurance policy for the policy owner for the benefit of the beneficiary, where the life insurance policy has a defined policy term. The method and system further includes, upon the death of the insured party within the policy term, paying a recurring expense for a benefit period for the beneficiary under the terms of the recurring expense life insurance policy.

In one embodiment, the method and system further includes generating the recurring expense life insurance policy in conjunction with a standard life insurance policy and including a recurring expense life insurance premium cost in a premium cost for the life insurance policy. It is recognized that in one embodiment, the recurring expense life insurance policy may be provided at no additional cost to the cost of the life insurance policy.

In one embodiment, the method and system further includes generating the specified or recurring expense life insurance policy in conjunction with a point of sale transaction and including a specified or recurring expense life insurance premium cost in the recurring expense determined at the point of sale transaction. It is recognized that in one embodiment, the recurring expense life insurance policy is provided at no additional cost to the cost of the point of sale transaction. In other embodiments, the life insurance policy is provided at a much lower cost than traditional insurance products, or at a cost proportional to the specified or recurring expense.

In some embodiments, the life insurance product is obtained directly through the point of sale vendor of the specified or recurring expense. In other embodiments, the life insurance product is obtained directly through a provider such as an insurance company, without an insurance agent. In other embodiments, a traditional insurance agent may be used to obtain the specified or recurring expense life insurance product.

In one embodiment, a system and method may further include receiving a plurality of recurring expense obligation selections from a policy owner. The recurring expense obligation selections relate to recurring expense obligations of either the policy owner or the beneficiary. In one embodiment, the system and method may further include updating the recurring expense life insurance policy based on the recurring expense obligations for the payment of the plurality of recurring expense obligations in the event of the death of the insured party within the policy term.

In one embodiment, the recurring expenses may be related to basic needs expenses such as heat, electricity, phone, cable and the like. In another embodiment, the recurring expenses may be related to educational expenses, such as the payment of tuition payments or designated education savings plan contributions for a defined benefit time period upon the death of the insured. In one embodiment, the recurring expenses may relate to housing expenses, such as making a mortgage payments or rent payments for the benefit of the beneficiary for the benefit period. In one embodiment, the recurring expenses may relate to healthcare expenses.

In one embodiment, the specified or recurring expense life insurance policy may make payments directly to a party that provides the product or service which causes the specified or recurring expense to be incurred. In another embodiment, the specified or recurring expense life insurance policy may make payments to the beneficiary for the sole purpose of being paid by the beneficiary to the provider of the product or service which causes the specified or recurring expense to be incurred. In another embodiment, the specified or recurring expense life insurance policy may make payments to a third party through which payment of the specified or recurring expense had been paid in the insured's life, such as a bank or on-line bill payment service.

### BRIEF DESCRIPTION OF THE DRAWINGS

The invention is illustrated in the figures of the accompanying drawings which are meant to be exemplary and not limiting, in which like references are intended to refer to like or corresponding parts throughout, and in which:

FIG. 1 illustrates one embodiment of a system for providing life insurance for a specified or recurring expense;

FIG. 2 illustrates a flowchart of the steps of one embodiment of a method for providing life insurance for a specified or recurring expense;

FIG. 3 illustrates one embodiment of a system for providing life insurance for a specified or recurring expense between a life insurance agent and a policy owner;

FIG. 4 illustrates a flowchart of the steps of one embodiment of a method for providing life insurance for specified or recurring educational expenses;

FIG. 5 illustrates a flowchart of the steps of one embodiment of a method for providing life insurance for specified or recurring housing expenses;

FIG. 6 illustrates one embodiment of a system for providing life insurance for a specified or recurring expense as selected by a policy owner;

FIG. 7 illustrates one embodiment of a system for providing life insurance for a specified or recurring expense in conjunction with a point of sale transaction; and

FIG. 8 illustrates a flowchart of the steps of one embodiment of a method for providing life insurance for specified or recurring expenses in conjunction with a point of sale transaction.

### DETAILED DESCRIPTION OF THE PREFERRED EMBODIMENTS

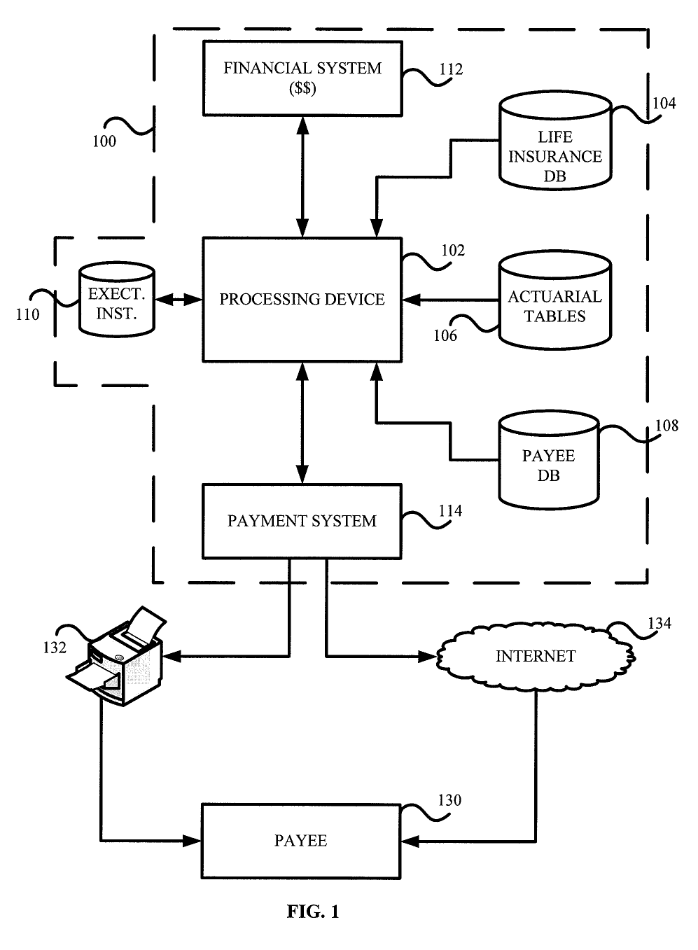

More specifically, FIG. 1 illustrates a system 100 that allows for providing a specified or recurring expense life insurance policy. The system 100 includes a processing device 102, a life insurance database 104, a plurality of actuarial tables 106 and a payee database 108. Additionally, the system 100 includes a memory device 110 having executable instructions stored therein, in communication with the processing device 102 for providing the executable instructions thereto. In the embodiment illustrated in FIG. 1, the system 100 also includes a financial system 112 and a payment system 114, but it is recognized that these systems may be outside of the system 100, disposed in one or more ancillary systems in communication with the system 100. It should also be recognized that the systems may be comprised of one or more computers and/or servers in the same or in different locations.

The processing device 102 may be one or more processing components capable of performing one or more processing operations in response to the executable instructions as stored in the storage device 110. The databases 104, 108 and the actuarial table 106 may be one more standard memory devices operative to store and allow later retrieval or access of information stored therein. The life insurance database 104 may store life insurance account information therein, such as tracking information relating to various policy owners, policy terms, beneficiaries, etc. The life insurance database 104 may also contain personal data useable for underwriting the corresponding life insurance policies. The actuarial tables 106 include one or more tables useable in the underwriting process, which may also be useable in underwriting recurring expense life insurance policies, if needed, or may be used in generating corresponding life insurance policies that the recurring expense life insurance policy compliments. The payee database 108 may include the name and payment information for various parties that would receive recurring payments in the event of the death of an insured party.

The financial system 112 may be one more processing systems or devices operative to handle financial aspects relating to recurring expenses, such as for example a banking system that includes account information. The payment system 114 may be a separate system from the financial system or may be embedded therein, providing for subsequent payments of recurring payments.

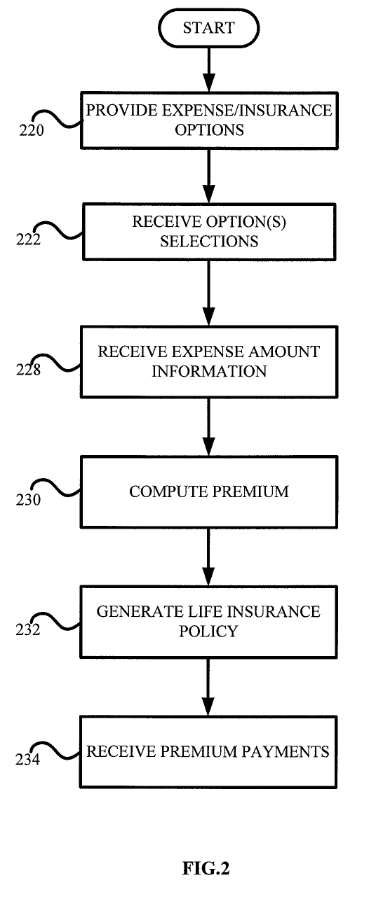

In one embodiment, the operations of the system 100 may be further illustrated with respect to the methodology steps of the flowchart of FIG. 2. At step 220, expense insurance options are provided to a prospective insured or policy owner. In some embodiments, options are provided via a computer graphical user interface accessed via a network such as the Internet and in others options may be provided telephonically or paper materials. A wide variety of presentation means may be used, including presentation of the options in insurance brochures, marketing materials or applications, applications for a specified product or service, including the specified product or service for which an insurance policy may be obtained.

A virtually unlimited number of options may be provided, with each option corresponding to a specified recurring expense of the insured along with associated life insurance for the expense. In some embodiments, the option may include a specific designated product or service with its corresponding recurring expense value indicated. For instance, the specific designated product might be telephone service provided by a known service carrier such as Verizon, specified as, for example, “Verizon Telephone Service,” coupled with a life insurance option to pay a benefit equal to the amount of the cost of the telephone service on a monthly basis, for a period of time, such as six months or a year, or another set time period. In some embodiments, the options may identify an estimated price range for the expense, given certain conditions such as details concerning the precise nature of the service to be obtained (e.g., unlimited calling plan), along with the price for the insurance policy under such conditions. In other embodiments, the option will consist of a generic expense category such as “telephone service” and will indicate availability of an insurance policy on terms to be determined based on further criteria provided, as described with respect to subsequent steps of FIG. 2.

At step 222, in some embodiments, a selection of one or more options is received. Based on the selection, in some embodiments, at step 228, additional information will be received concerning the amount of the recurring expense. For instance, in an embodiment where a generic expense category such as “telephone service” is selected, information concerning the provider of the service (e.g., the service carrier), the cost of the service for each recurring interval (e.g., monthly payments of $150.00), and the party in whose name the service is listed (e.g., the insured), will be obtained. Other information may also be obtained, such as any contractual term for the service. For example, in the case of cellular telephone service, where a contractual term of two years is required, the two year term and/or expiration date for the contract may be provided.

At step 230, a premium is computed based on the selected options and amount of each associated expense. In some embodiments, the premium calculation may be primarily preset based on specific options provided. For example, in the case of an option for “Verizon Telephone Service,” step 230 involves applying a preset premium amount to the insurance policy to be issued based on the price provided with the option. In some embodiments, variations to the insurance policy premium price may be offered based on other factors, such as the insured's ownership of other recurring expense insurance policies or other standard life insurance products. For instance, a discount may be provided to insureds who are also owners of a standard life insurance policy with the insurance provider. In other embodiments, pricing variations may be provided based on the quantity of policies purchased. For example, in the case of a financial institution seeking to obtain a recurring expense insurance policy to protect against non-payment by multiple individuals to whom the financial institution has provided loans, the insurance provider may offer a discount based on the number of policies obtained. It should be noted that this reflects another embodiment wherein a third party, such as a financial institution, is obtaining recurring expense life insurance on an insured to protect its own investment in the event of the death of the insured.

In other embodiments, step 230 involves computing a premium based on expense amount provided on an individual basis. For instance, in the case where a generic service is selected and information has been obtained concerning the service, as discussed above, the step of computing a premium involves calculations based on the specific expense information received, such as the cost of the expense per recurrence period and the term of insurance protection desired.

In the system of FIG. 1, step 230 may include operations performed by the processing device 102 in response to the executable instructions, including receiving information associated with the specified or recurring expense and the insured. In an embodiment, for example, if the specified or recurring expense relates to a household expense, such as an electric bill, the processing device may process information defining who is the insured party, who is the beneficiary, what is the term of the policy, what is the benefit period of the policy (e.g. how long will the recurring expense be paid), as well as information of the recurring expense itself, such as to whom the payment is made and how much the recurring expense is. If the generation of recurring expense policy compliments an existing policy, this step may include re-using existing data wherever possible.

The underwriting process may be conducted consistent with standard underwriting techniques, including referencing actuarial tables or other calculation information for generating a premium amount for the policy. In another embodiment, the underwriting may recognize the relative scale of the recurring payments to a larger policy and absorb premium costs as a marketing expense to capture new customers or enhance the insurance portfolio of existing customers. As described in further detail below, in a point of sale embodiment, the premium may be calculated based on underwriting techniques or in another embodiment may be based relative to the point of sale transaction instead of being based relative to the specifics of the insured parties, as with a standard life insurance policy.

In the system 100 of FIG. 1, the insurance information may be stored in the database 104 and the payee information may be stored in the payee database 108. Financial information, such as the timeliness and amount, may be stored in the financial system 112. Should premiums be required, payment of these premiums may also be logged through the various components of the system 100, in accordance with existing life insurance processing techniques.

Referring back to the methodology of FIG. 2, at step 232, a life insurance policy for the insured is generated based on the option selections and premium computation, and at step 234, insurance premiums are received for the policy.

In some embodiments, after the insurance policy is issued, changes may be made to the issued policy to reflect changes in the recurring service. For instance, a policy owner may wish to change the beneficiary, as in the case of the addition of a dependent, or if payment is to be made directly to a service provider, a change in the service provider. Many other modifications are possible consistent with the invention.

Referring back to FIG. 1, the system 100 may include processing operations performed by the processing device 102 for accessing the financial system 112 to process one or more payments through the payment system 114. The processing device 102 may access the life insurance database 104 to extract life insurance terms, access the payee database to determine which parties are to receive payments and access the financial system 112 to make funds available. In one embodiment, the payment system 114 thereupon provides for the recurring or periodic payment to the payee 130, such as using a printing device 132 to print a check, which can be mailed, or an electronic payment made to the payee 130 through a network connection 134, such as the Internet. The payment of benefits may be made using existing online banking or electronic checking systems, as available, such as bank accounts having online capabilities or electronic banking service providers such as Checkfree or Paytrust.

In another embodiment, the payment system 114 may make the payment to the beneficiary instead of the payee, where the payment is made for the sole purpose of paying the recurring expense. This is differentiated from the embodiment where a beneficiary may also receive a death benefit from a life insurance policy because the death benefit associated with a standard life insurance policy does not include any specific restrictions. Although, it may be preferable for the recurring payment to be made directly to the payee to alleviate a beneficiary from having to deal with additional issues while also dealing with the loss of the insured.

In some embodiments, after the payment of the recurring expense for the beneficiary, a next step is to determine if the benefit period has expired. By way of example, the benefit period may be for a calendar year or may be determined by other factors, such as relating to the underlying expense, such as tuition payments may be made for the duration of a school year. If the benefit period has not ended, the method, in some embodiments, reverts back to the payment of the recurring expense in accordance with the terms of the recurring expense life insurance policy. For example, if the policy covers a monthly recurring expense, the payment may be made on a monthly basis. It is also recognized that in one embodiment, the payment does not necessarily have to be strictly in accordance with the corresponding terms of the recurring expense, such as if the recurring expense is a defined monthly amount for twelve months in a row, the payment of step 126 may be a one-time payment covering all twelve months at once.

In one example, a policy may be written to cover either or both a husband and wife who may cover different expenses out of a joint checking account. They may get this policy to make sure that if either dies, the other will not have to worry about writing checks and depleting the savings account while having to deal with the loss. They purchase coverage to make sure that the insurance provides pays the selected bills, such as the electricity and heating bills, automatically for twelve months after his or her death. This would postpone handling financial issues so the surviving spouse could deal with the pressing emotional hardship.

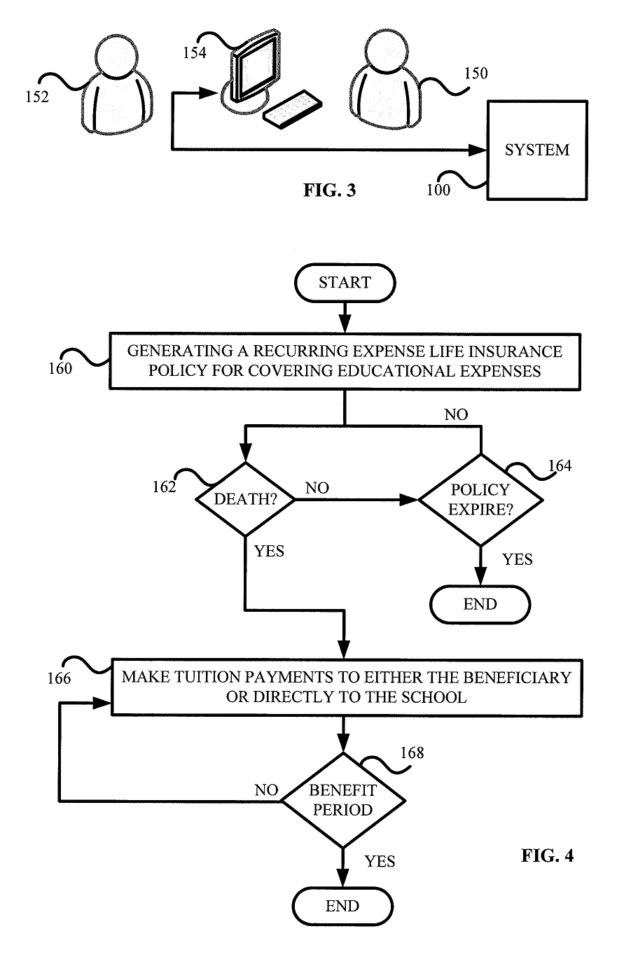

FIG. 3 illustrates one embodiment for the generation of a recurring expense life insurance policy between an insurance agent 150 and a policy owner 152. The agent 150 operates a computing device 154 connected to the system 100 of FIG. 1. The system of FIG. 3 allows for the generation or management of standard life insurance policies for policy owners as well as the ability to compliment to the life insurance policy by adding a recurring expense life insurance policy using the system 100, such as at the time of the generation of the standard life insurance policy or at a later time. As used herein, a standard life insurance policy may be any suitable type of life insurance policy that provides one or more generalized death benefit payments to a beneficiary, such as a term life insurance policy or a whole life insurance policy, by way of example. General interfacing techniques, as known by those skilled in the art, may be utilized to facilitate interoperability of the system 100 and the computing 154, as well as presenting user selection screens such that the recurring expense information may be received and processed by the system 100.

FIG. 4 illustrates a flowchart of the steps of one embodiment of a recurring expense life insurance policy directed to an educational expense. As used herein, an educational expense may be any suitable expense related to education, such a tuition payments, educational savings or individual retirement account plans, e.g. 529 plans, by way of example.

In this embodiment, a first step, step 160, is generating a recurring expense life insurance policy for covering educational expenses. This generation may be similar to the generation step 120 of the flowchart of FIG. 2, such as using the processing system 100 of FIG. 1 in conjunction with an insurance agent 150 of FIG. 3. This generation step may include defining the payment terms, such as for example if it is a tuition payment, how much is the tuition. The generation may also include the additional information of to whom payment would be made, when payment is due, how long the policy is in effect, the length of the benefit period, as well as any other suitable information.

After the policy is generated, the next step, step 162, is to determine if the insured party dies. If answered in the negative, step 164 is to check if the policy has expired. If the policy expires without the death of the insured, the policy and thereby this methodology ends. It is recognized that the policy owner may seek to renew the policy or generate a new policy, such as for the next academic school year, and would therefore begin back through repetition of step 160.

If the inquiry to step 162 is in the affirmative, meaning that the insured has died, the next step is to make recurring payments to either the beneficiary or the school, step 166. In the event educational expenses are tuition expenses, step 166 may include the insurance policy issuing company making timely tuition payments on behalf of the beneficiary directly to the school. If the education expenses are education savings related, the insurance policy issuing company may make timely deposits to one or more corresponding savings accounts. It is also recognized that the insurance policy issuing company may also contract out payment operations to be fulfilled by one or more third party vendors. Additionally, as noted in step 166, payment may be made directly to the beneficiary or a guardian of the beneficiary for the sole and explicit purpose of paying the designated education expenses.

In this method, a next step, step 168, is to determine if the benefit period is still in effect. For example, supposed the benefit period was defined as a single calendar year from the date of death for making tuition payments. If answered in the negative, step 168 thereby reverts back to step 166 where additional payments are made. It is recognized that in one embodiment, a lump sum payment may be made instead of recurring payments, such as paying the full tuition for an academic calendar year, thereby in this embodiment, the benefit period may be shortened to reflect the one-time payment structure.

The methodology continues making payments 166 until the inquiry of step 168 is in the affirmative, meaning that the benefit period has expired. Upon its expiration, the methodology is complete and the terms of the recurring expense insurance policy have been satisfied. Thereby, the beneficiary has the security of the recurring payments satisfied while dealing with grieving issues associated with the loss of the insured.

In the embodiment of recurring expenses relating to educational expenses, another embodiment, as described in further detail below, may relate to the point of sale side of the transaction. For example, one embodiment may include the generation or management of the recurring expense life insurance policy when a student loan or an enrollment contract with monthly tuition payments is originated. In the example of a student loan, the loan underwriter may seek to include the insurance policy in the details of the transactions, either directly or in another embodiment through a relationship with an insurance underwriter. Additional benefits may be realized, such as offering lower interest rates as the insurance policy reduces the risk level of the student loan transaction, by way of example.

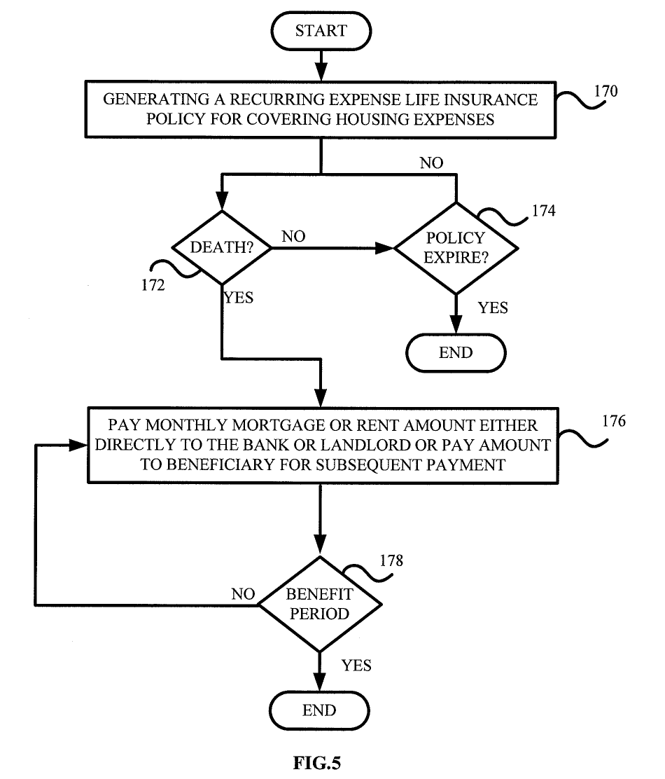

FIG. 5 illustrates a flowchart of another embodiment of a recurring expense life insurance policy. For the sake of brevity, the steps 170, 172, 175, 176 and 178 of FIG. 5, generally speaking, mirror the steps of FIG. 4. Although, by distinction, the methodology of FIG. 5 relates to housing expenses instead of educational expenses. Therefore, in step 170, the generation of the recurring housing expenses life insurance policy may include defining a monthly mortgage or rental expense, as well as defining the terms of how much rent or mortgage payment is, to whom payment is made, etc.

In step 172, in the event of the death of the insured, step 176 provides for, in this embodiment, the monthly mortgage or rent amount to be paid directly to a landlord or a mortgage lending institution. Additionally, the payment may be made to the beneficiary for the explicit and sole purpose of making the rent/mortgage payment. Additionally, the insurance policy may include making a one-time lump sum payment to beneficiary or the landlord/mortgage company for the defined time period.

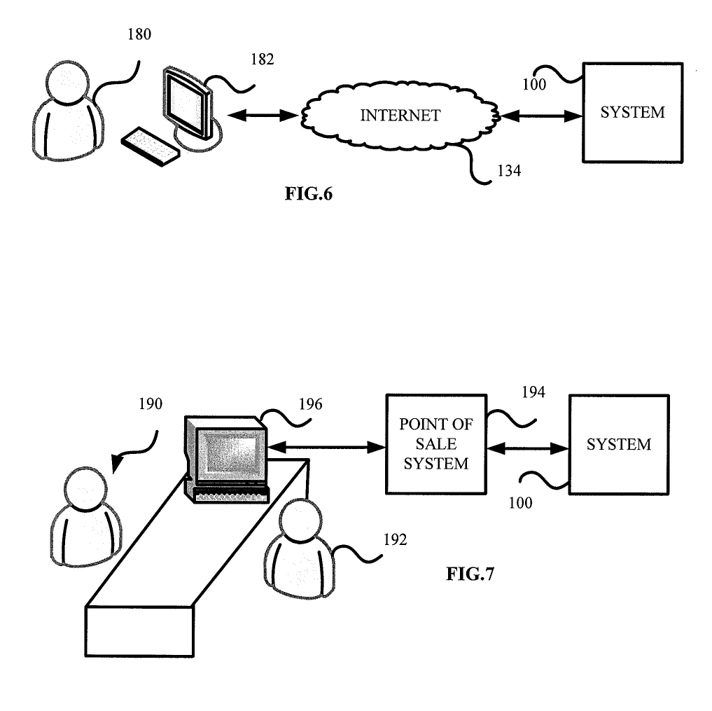

FIG. 6 illustrates another embodiment of a scenario in which a customer signs up with the insurance company and becomes a policy owner 180 so that the policy owner may generate or augment recurring life insurance policies. The policy owner 180 may utilize a computing device 182, connectable through a network connection, such as the Internet 134, to the system 100. It is recognized that the system 100 may include additional networking and user interface functionality providing for the policy owner 180 to access the policy information, where this interfacing and networking technology may use existing and known techniques.

In one embodiment, the policy owner 180 may log onto an insurance company web site, through the computer 182 via the Internet 134. The policy owner 180 may select a list of various recurring expenses eligible for recurring expense insurance policies. Generally speaking, the recurring expenses may be broken down into four basic categories: basic needs, educational expenses, housing expenses, and health insurance needs.

Through these different options, the policy owner 180 could, in effect, make an a la carte selection of different recurring expenses and the receive price quotes for the premium costs. In one embodiment, if the recurring expenses are small enough, the policy owner may be granted these policies without having to pay a premium, such as the example of the recurring expense life insurance policy being a fringe benefit of the policy owner owning a larger standard life insurance policy. Thus, the policy owner 180 may add, supplement or change recurring expense life insurance policies consistent with insurance planning needs and/or goals.

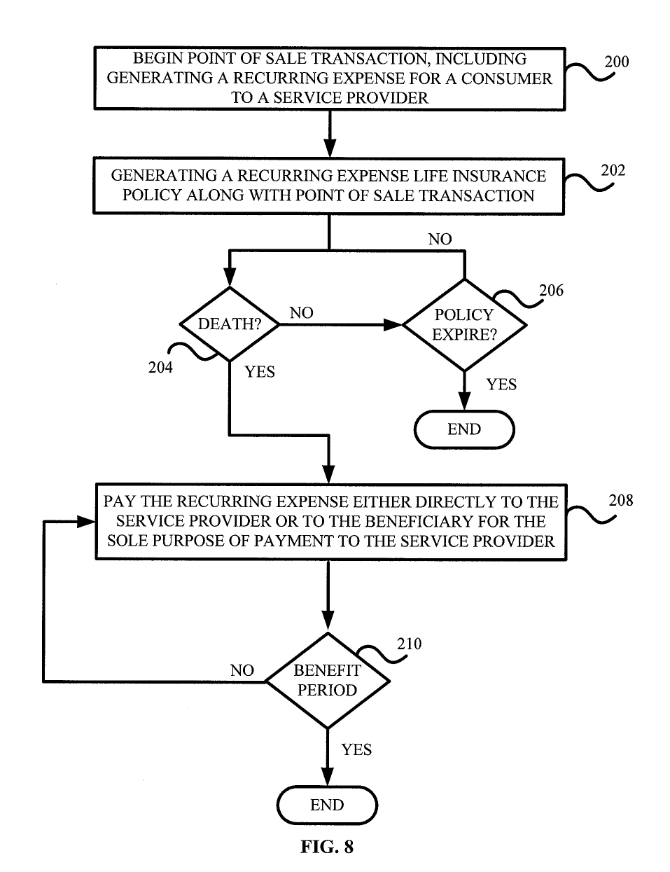

FIG. 7 illustrates another embodiment of the generation of the recurring expense life insurance policy, being combined with a point of sale transaction between a customer 190 and a salesclerk 192. In this embodiment, the salesperson 192 may be selling a service through a point of sale system 194, such for example the customer 190 purchasing a mobile phone with a family plan having monthly recurring expenses. It is recognized that various levels of complexity of point of sale systems may be envisions, including for example back end enterprise applications or systems.

Regardless of the specific implementations of the point of sale system 194, the system 194 is capable of being in communication with the system 100. The communication between systems 194 and 100 may be conducted using known interfacing techniques for providing the exchange of information therebetween.

As discussed with respect to FIG. 7, FIG. 8 illustrates a flowchart of the steps of one embodiment of a recurring expense life insurance policy associated with a point of sale transaction. The method begins, step 200, with the start of the point of sale transaction including generating a recurring expense for a consumer to a service provider. In the system of FIG. 7, the consumer 190 may be purchasing, for example, the mobile phone from the sales clerk 192 working for (or an authorized retailer of) the mobile phone carrier. The clerk 192 enters purchase information into a sales terminal 196 connected to the point of sale system 194, such as registering the mobile phones and signing the customer 190 up for a telephone service contract. A typical mobile phone contract may be for twelve or twenty four months with a preset monthly costs for a selected billing plan, therefore between the customer 190, the sales clerk 192 and the point of sale system 194, a commercial transaction may be conducted obligating the customer 190 under the contract to pay the service provider a determined amount on a monthly basis.

The next step in the flowchart of FIG. 8, step 202, is generating a recurring expense life insurance policy along with the point of sale transaction. In the system of FIG. 7, the point of sale system 194 may interact with the system 100 to generate a recurring expense life insurance policy. In this example, the policy may be automatically generated, naming a family member as the beneficiary, the customer 190 (or the primary income earner in the family) as the insured party and culling the additional information as may be needed, e.g. monthly amount, length of contract, payee, etc. Additionally, the recurring expense life insurance policy may be generated by the service provider, an insurance company or any other suitable party as may be recognized by one skilled in the art. For example, the service provider may offer this features as an added contractual element when signing up new customers. In another example, the service provider may work in partnership with the insurance provider to provide this insurance policy, or in another embodiment, the customer may already have a relationship with the insurance provider for this service, so that the insurance aspects to the transactions could be invisible to the service provider. In another embodiment, another entity may provide the insurance as a benefit, such as selling add-on features to an item being purchased and including insurance as an additional benefit.

In one embodiment, the recurring expense life insurance policy may have a premium associated therewith, where this premium may be simply added back into the recurring expense of the commercial transaction. In another embodiment, the policy may not have a premium charge to the customer, such as a marketing tool or insurance tool used by the service provider or an insurance carrier to provide additional levels of customer service to customers. In some embodiments, the premium may be paid to the provider of the product or service for which the expense is incurred. The provider may in some instances forward the payment to the insurance provider (or its financial institution). For example, if a monthly recurring expense is $75 and includes a monthly premium of $2.50, using known financial routing techniques, the service provider may extract the $2.50 from the $75 and forward that money directly to the insurance carrier, keeping the $72.50 as payment for the service provided.

In another embodiment, the recurring expense life insurance policy may have a full premium due at the close of the original transaction. By way of example, a person may sign up for a monthly utility of electricity from the power company. When signing up for this utility, the person also signs up for the recurring expense life insurance policy to cover monthly electrical bills. In one embodiment, the monthly utility bill could include a monthly premium amount. In another embodiment, the person could be charged a one-time up-front cost for the policy.

In another exemplary embodiment, a person may finance the purchase or lease a motor vehicle and seek the recurring expense life insurance policy described herein. When completing the financing transaction, the person could pay an upfront premium fee covering a defined period of time, such as a set number of years or months or in another embodiment a period of time corresponding to the length of the financing transaction. In another embodiment, the premium could be broken up and paid in monthly installments.

For the sake of brevity, step 204, 206, 208 and 210 of this methodology may be similar to the steps 162, 164, 166 and 168, respectively of FIG. 4. More specifically, the methodology includes tracking whether the insured party has died, step 204, prior to the expiration of the policy, step 206. If death occurs, the insurance policy provides for the payment of the recurring expense associated with the point of sale transaction, step 208. Similarly, the payment may be made directly to the service provider or other designated payee, or may be made to the beneficiary for the sole purpose of paying the recurring expense. Additionally, the payments are made for the duration defined by the benefit period, step 210. Thereby, in this embodiment, the method is complete. It is also recognized that the above point of sale example of a mobile telephone is not a limiting embodiment, but merely exemplary in nature and the recurring expense life insurance policy may be associated with any suitable point of sale transaction.

In another example, a common recurring expense relates to basic needs, including utility bills. One embodiment may include automatic recurring expense insurance protection for customers, where the utility company, a third-party service provides or an insurance carrier can provide or otherwise underwrite the large volume of insurance policies, where the premium payments and other aspects may be handled in accordance with any of the various above-described embodiments.

Through the above-described embodiments, a policy owner may acquire a recurring expense life insurance policy exclusively covering recurring expenses that can reduce the burden on a family dealing with a loss. The recurring expense life insurance policy provides specific and directed payments for policy-designated expenses, thereby alleviating the short-comings of disability insurance that fail to cover death and standard life insurance policies that make general payments, still requiring grieving loved ones to address individualized recurring expenses during a difficult time.

FIGS. 1-8 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer or processing system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the term memory device generally refers to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment. Other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, it is not intended for any term in the specification or claims to be ascribed an uncommon or special meaning unless explicitly set forth as such. Further, the present invention encompasses present and future known equivalents to the known components referred to herein by way of illustration.

While the invention has been described and illustrated in connection with various embodiments, many variations and modifications as to be evident to those of skill in the relevant art(s) may be made without departing from the spirit and scope of the invention, and the invention is thus not to be limited to the precise details of methodology or construction set forth above, as such variations and modifications are intended to be included within the scope of the invention. It is to be understood by those of ordinary skill in the relevant art(s) that the various data processing tasks described herein may be implemented in a wide variety of ways, many of which are known and many more of which are doubtless to be hereafter developed. For example, a wide variety of computer programs and languages are now known, and are likely to be developed, which are suitable for storing, accessing, and processing data, as well as for performing, processing, and using actuarial forecasts and other analyses as disclosed herein. Except to the extent necessary or inherent in the processes themselves, no particular order to steps or stages of methods or processes described in this disclosure, including the figures, is implied. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). Thus, the present invention should not be limited by any of the above-described exemplary embodiments, but should be defined only in accordance with the following claims and their equivalents.

What is claimed is:

1. A method of providing life insurance for an insured, the method comprising:
providing a plurality of options wherein each option corresponds to any recurring expense of the insured and life insurance for said recurring expense;
receiving a selection of one or more options of the plurality of options;
receiving information relating to the amount of the expense associated with each of the one or more selected options;
computing a premium for providing the life insurance policy based at least in part on the one or more selected options and the amount of each associated expense;
generating a life insurance policy for the insured based at least in part on the selection; and
receiving one or more premium payments for the life insurance policy.

2. The method of claim 1, wherein the recurring expense comprises one of a set of: an existing expense, a future expense, a potential expense.

3. The method of claim 1, wherein the recurring expense comprises one of a set of: a mortgage expense, a rental expense, a lease expense, a utility expense, a transportation expense, a food expense, an education expense.

4. The method of claim 1, wherein the amount of the expense is variable.

5. The method of claim 1, wherein the amount of the expense is fixed.

6. The method of claim 1, wherein an entity other than the issuer of the life insurance provides the plurality of options.

7. The method of claim 1, wherein an entity other than the issuer of the life insurance receives the one or more premium payments.

8. The method of claim 1, wherein generating a life insurance policy comprises generating a life insurance policy providing for benefits to be paid directly to a provider of a product or service for which a recurring expense is incurred.

9. The method of claim 1, wherein providing the plurality of options includes providing an option for a product or service for which a recurring expense will be incurred.

10. An system for providing life insurance for an insured, the system comprising:
a processing device, in response to executable instructions, operative to:
provide a plurality of options wherein each option corresponds to any recurring expense of the insured and life insurance for said recurring expense;
receive a selection of one or more options of the plurality of options;
receive information relating to the amount of the expense associated with each of the one or more selected options;
compute a premium for providing the life insurance policy based at least in part on the one or more selected options and the amount of each associated expense;
generate a life insurance policy for the insured based at least in part on the selection; and
receive one or more premium payments for the life insurance policy.

11. The system of claim 10, wherein the recurring expense comprises one of a set of: an existing expense, a future expense, a potential expense.

12. The system of claim 10, wherein the recurring expense comprises one of a set of: a mortgage expense, a rental expense, a lease expense, a utility expense, a transportation expense, a food expense, an education expense.

13. The system of claim 10, wherein the amount of the expense is variable.

14. The system of claim 10, wherein the amount of the expense is fixed.

15. The system of claim 10, wherein an entity other than the issuer of the life insurance provides the plurality of options.

16. The system of claim 10, wherein an entity other than the issuer of the life insurance receives the one or more premium payments.

17. The system of claim 10, wherein generating a life insurance policy comprises generating a life insurance policy providing for benefits to be paid directly to a provider of a product or service for which a recurring expense is incurred.

18. The system of claim 10, wherein providing the plurality of options includes providing an option for a product or service for which a recurring expense will be incurred.
